(19) United States
(12) Patent Application Publication
(10) Pub. No.: US 2018/0031381 A1
(43) Pub. Date: Feb. 1, 2018

(54) SYSTEMS AND METHODS TO MANAGE FILLING AN ENERGY SOURCE IN A SHARED VEHICLE

(71) Applicant: Ford Global Technologies, LLC, Dearborrn, MI (US)

(72) Inventor: Aurelien Pierre Christian Delaruelle, Victoria (AU)

(21) Appl. No.: 15/657,477

(22) Filed: Jul. 24, 2017

(30) Foreign Application Priority Data
Jul. 29, 2016 (CN) 201610617863.2

(51) Int. Cl. G01C 21/34; G06Q 10/08; G01F 23/00; G06Q 10/06

(52) U.S. Cl. CPC G01C 21/3469; G06Q 10/063114; G06Q 10/06393; G06Q 10/06315; G06Q 10/0637; G06Q 10/0875; G01F 23/0076

(57) ABSTRACT

A system to manage filling an energy source in a shared vehicle by a plurality of users is disclosed. The system comprises a user identification device to identify a user when the vehicle is started; an energy source filling management device configured to determine energy consumption relative to an allowance allocated for an identified user; and an in-vehicle device to display information on the energy consumption relative to the allowance.

### RELATED APPLICATION

This application claims the benefit of Chinese Patent Application No.: CN 201610617863.2 filed on Jul. 29, 2016, the entire contents thereof being incorporated herein by reference.

### FIELD

The present disclosure relates to a system and a method to manage filing an energy source in a vehicle, specifically relates to a system and a method to manage filing an energy source in a vehicle shared by a plurality of users.

### BACKGROUND OF THE INVENTION

In a shared vehicle, the different users share an energy source such as a fuel tank or a battery. The current options for the responsibility to fill the fuel tank or charge the battery in a shared vehicle have drawbacks. In one option, a third party is used to maintain sufficient energy in the vehicle, which has extra cost. In another option, a person who ends up with the empty tank is responsible to fill the tank or charge the battery. As the fillings or charging are random, the same person might take the responsibility most of the time even if he or she does not use the vehicle often. Such arrangement may be frustrated. In yet another option, it is the responsibility of each driver to always fill the fuel tank or charge the battery after they have used the vehicle, which is not practical, especially for a short journey. The inventor has recognized the need for a system that allows an individual driver to manage fuel refilling in the shared vehicle.

### SUMMARY

According to one aspect of the present disclosure, a system to manage filling an energy source in a shared vehicle by a plurality of users is disclosed. In the shared vehicle, each user may be allocated an allowance of energy stored in the energy source. The system may comprise a user identification device to identify a user when the vehicle is started; an energy source filling management device configured to determine energy consumption relative to the allowance for an identified user; and an in-vehicle device to display information on the energy consumption relative to the allowance.

In one embodiment, the information on the energy consumption may include at least one of a percentage of allowance remained for the identified user, a scale indicating the energy consumption with the allowance as a full capacity, and an amount of energy needed to be refilled.

In another embodiment, the energy source filling management device may further be configured to instruct the user to refill the energy source via the in-vehicle device when the energy used by the identified user reaches a predetermined value. The predetermined value may be lower than the allowance allocated to the identified user.

In another embodiment, the system may further comprise a refilling regulator coupled in the energy source and configured to stop energy refilling when the energy is filled to the allowance of the identified user.

In another embodiment, the energy source filling management device may be configured to allow filling to a full capacity of the energy source upon a user's request via the in-vehicle device.

In another embodiment, the energy source filling management device may further be configured to record an energy level for the identified user after each trip and determine the current energy consumption relative to the allowance according to a difference between an energy level of a previous trip and a current energy level measured by an energy gauge, and the allowance.

In another embodiment, the plurality of users includes two users, three users or four users.

In another embodiment, the allowance is evenly allocated among the plurality of users.

In another embodiment, the vehicle may be a gasoline powered vehicle, the energy source may be a fuel tank, and the refilling regulator may be a moveable flap that enables opening and blocking a fuel passage.

In another embodiment, the vehicle may be an electric vehicle, the energy source may be a battery, and the refilling regulator may be a switch that enables connecting and disconnection a circuit to charge the battery.

According to another embodiment, a system to manage filling an energy source in a shared vehicle by a plurality of users is disclosed. The system may comprise a user identification device to identify a user of the shared vehicle when the vehicle is started; an energy source filling management device configured to determine energy consumption relative to an allowance allocated to the identified user and time to issue an alert to refill the energy source; and an in-vehicle device to display the energy consumption relative to the allowance by the identified user.

In one embodiment, the energy source filling management device may further be configured to issue the alert when the energy used by the identified user reaches a predetermined value. The predetermined value may be lower than the allowance allocated to the user, and the alert may be displayed in the in-vehicle device.

In another embodiment, the system may further comprise a refilling regulator to stop refiling the energy source when the energy is filled to the allowance

According to another aspect, a method to manage filling an energy source in a shared vehicle by a plurality of users is disclosed and each user is allocated to an allowance. The method may comprise identifying a user when a vehicle is started; determining an amount of the energy consumption relative to the allowance for the identified user; and displaying the energy consumption information of the user on an in-vehicle device.

In one embodiment, the method may further comprise alerting fuel refilling when the energy consumption by the identified user reaches a predetermined value. The predetermined value may be lower than the allowance.

In another embodiment, alerting fuel refilling may include showing a sign that the energy source needs to be refilled on a cluster of an instrument panel, issuing an audio notice, or displaying a written notification on a cluster of an instrumental panel or a screen of an HMI device.

In another embodiment, the method may further comprise stopping to refill the energy source by a refill regulator when the energy source is filled up to the allowance for the identified user.

In another embodiment, the energy source may be a fuel tank, and the refilling regulator may be a moveable flap that opens and blocks a fuel passage in the fuel tank.

In another embodiment, the energy source may be a battery, and the refilling regulator may be a switch that connects and disconnect a charge circuit.

In another embodiment, the user may be identified by a fingerprint, a voice, a facial feature, an electronic chip embedded in a vehicle key, or via a near field communication technology.

The systems and the methods of the present disclosure allocate an allowance of an energy source to each user of a shared vehicle and display the energy consumption information relative to an allowance for an individual user. In this way, each user can manage refiling the energy source as if each user has his or her individual energy source in the vehicle.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a block diagram of an example vehicle system in which an example embodiment of an energy source filling management system of the present disclosure may be implemented.

FIG. 2 is an example fuel tank installed with a flap as a refilling regulator.

FIG. 3 is an example battery charge circuit using a switch as a refilling regulator.

FIGS. 4A and 4B illustrate examples of fuel consumption relative to an allowance for a fuel tank in a vehicle shared by a plurality of users.

FIG. 5 shows an example display for one of a plurality of users in a shared vehicle.

FIG. 6 shows an example method to manage tilling an energy source in a vehicle shared by a plurality of users according to an embodiment of the present disclosure.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed system and method will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of systems and methods are provided. Related features in the examples may be identical, similar, or dissimilar in different examples. For the sake of brevity, related features will not be redundantly explained in each example. Instead, the use f related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

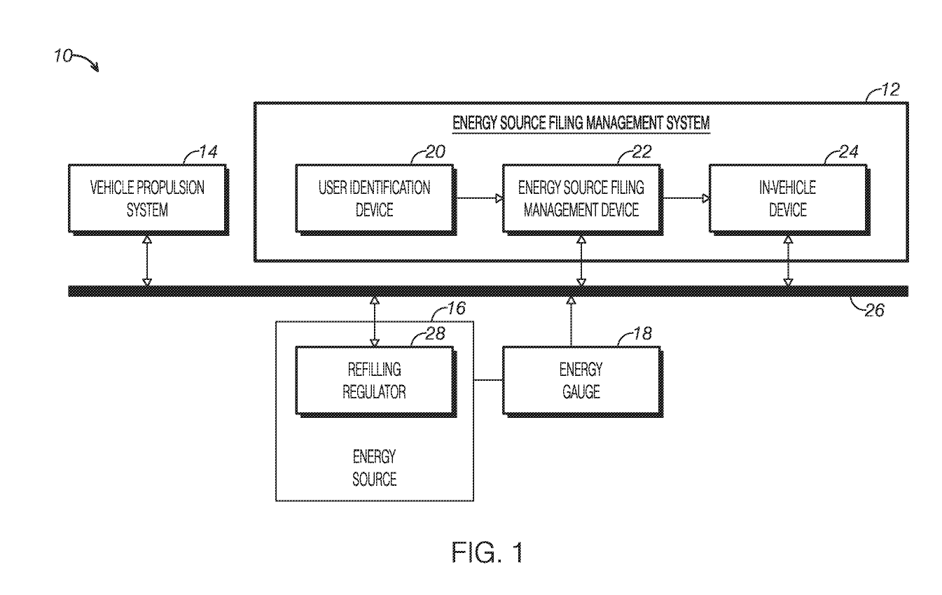

FIG. 1 is a block diagram of an example vehicle system 10 in which an example embodiment of an energy source filling management system 12 of the present disclosure may be implemented. The energy source filling management system 12 may be used in a vehicle shared by a plurality of users. The vehicle system 10 may include a vehicle propulsion system 14, an energy source 16 and an energy gauge 18. In some embodiments, the vehicle propulsion system 14 may include a gasoline engine or a diesel engine, that is, the vehicle may be powered or propelled by a gasoline engine or a diesel engine. The energy source 16 may be a fuel tank and the energy gauge 18 may be a fuel gauge indicating an amount of fuel in the fuel tank. In some embodiments, the vehicle propulsion system 14 may include a battery that powers an electric motor for the vehicle propulsion. The energy source 16 may be a battery and the energy gauge 18 may indicate a capacity of level of the battery.

The energy source filling management system 12 may further include a user identification device 20, an energy source filling managing device 22, and an in-vehicle device 24. The energy source filling management device 22 may be configured to allocate an allowance of energy stored in the energy source 16 to each user of the plurality of the users and determine the energy consumption relative to an allowance for an identified user.

The energy source filling management device 22 may include a processor that provides for computational resources. The energy source filling management device 22 may serve to execute instructions for software that may be loaded into a memory unit. The instructions may include program code, computer-usable program code, or computer-readable program code. The memory unit may be a storage device that is capable of storing information, such as, without limitation, data, program code in functional form, and/or other suitable information on either a temporary basis and/or a permanent basis. For example, the memory unit may include a random access memory or any other suitable volatile or non-volatile storage device and a persistent storage. The persistent storage may be one or more devices such as a hard drive, a flash memory, a rewritable optical disk, a rewritable magnetic tape, or some combination of the above.

The vehicle may be allocated to a plurality of users for driving for a certain period. In some embodiments, upon an input of information on the number of users for the vehicle, the energy source filling management device 22 may allocate an allowance of energy stored in the energy source 16 to each user. In some embodiments, the allowance may be allocated evenly among the users. For example, in a gasoline powered vehicle shared by three users, each user may be allocated to one third of volume of the fuel tank. In other words, each user is assigned a virtual tank having one third volume of the fuel tank. Each user is responsible for filling his or her virtual fuel tank or his or her fraction of the fuel tank. It should be appreciated that the volume of the tank may be allocated differently among the users. Similarly, the capacity of a battery in an electric vehicle may be allocated among the users.

The user may be identified by the user identification device 20. In some embodiments, the user identification device 20 may be a coded vehicle key and different users have different vehicle keys. In one embodiment, the vehicle key may be a mechanical key that starts the vehicle by inserting into a keyhole and turning a switch that connects the battery to the ignition system and other electrical devices of the vehicle. In another embodiment, the vehicle key may be a smart key that automatically unlocks, locks and starts the vehicle. When the user starts the vehicle using the coded vehicle key, the energy source tilling management device 22 recognizes the user via the output from the user identification device 20.

In some embodiments, the user identification device 20 may include a finger print recognition device. The finger print recognition device may be similar to the device conventionally used in a mobile phone. In one example, the finger print recognition may be incorporated into a vehicle start button. The user may be identified when the user presses the start button.

In some embodiments, the user identification device 20 may include a device that recognizes a facial feature. It should be appreciated that the user identification device may be any suitable device that can identify a user and enable the start of the vehicle. For example, the user may be identified via the near field communication (NFC) technology in which a user's smart phone or watch may be a device to communicate with the vehicle system. The vehicle system may start the vehicle when recognizing the user through the smart phone or the watch.

Once the user is identified, the energy source filling management device 22 may determine the energy consumption relative to the allowance for the identified user according to information from the energy gauge 18. The energy source filling management device 22 may be communicated with the energy gauge 18 via a communication bus 26 to obtain the information on energy consumption. For example, the energy source filling management device 22 may calculate a cumulative energy consumption by adding the energy consumption of the current trip to the energy consumption of the previous trips for the identified user. The energy consumption relative to the allowance for the identified user may be calculated and presented in any suitable format. For example, the energy consumption relative to the allowance may be presented as a percentage of energy consumption to the allowance for the identified user. In some embodiments, the energy source filling management device 22 may maintain the energy consumption log for each user to keep record the energy used by each user. The energy consumption may be set to zero after the user refills his or her portion of the energy source to the allocated allowance.

In some embodiments, the energy source filling management device 22 may be configured to instruct the user to refill the energy source via an in-vehicle device when the energy used by the user reaches a predetermined value. The predetermined value may be lower than the allowance allocated to the user. For example, the energy source filling management device 22 may determine when to send instruction or issue an alert to the identified user to refill the energy source.

The energy source filling management device 22 may further be communicated with an in-vehicle device 24 to display information on the energy consumption relative to the allowance for the identified user. In some embodiments, the in-vehicle device 24 may display the information on the energy consumption relative to the allowance. For example, the in-vehicle device 24 may display as a percentage of energy remained relative to the allowance or a percentage of energy consumed relative to the allowance. The in-vehicle device 24 may further present information on an amount of energy needed to be refilled. Additionally or alternatively, the in-vehicle device 24 may present a total amount of the energy in the energy source or energy consumption by all users of the vehicle. In some embodiments, the in-vehicle device 24 may display instructions or an alert to refill the energy source when the energy consumption by the identified user reaches a predetermined value. The alert may be a sign or flashing figure indicating the need to refill the energy source or may be an audio alert or a written message on a display of the in-vehicle device 24.

In some embodiments, the in-vehicle device 24 may be disposed on a cluster of an instrument panel of the vehicle. For example, the in-vehicle device 24 may be a display unit to present a written message or a graphic representation of the energy consumption for the individual user. In another example, the in-vehicle device 24 may be an audio device that issues an audio alert for the user to refill the energy source when the energy used by the user reaches the predetermined value.

In sonic embodiments, the in-vehicle device 22 may be a human machine interaction (HMI) device including a user interface having an input/output unit and a display. The HMI device may be a telecommunications and/or data processing device permanently or removably installed in the vehicle. The HMI device may provide features of energy source filling management among other features such as vehicle information, entertainment, navigation, and/or vehicle control. The HMI device may present information on the energy consumption relative to the allowance for the identified user as described above. Additionally or alternatively, the user may select a format of the information on the energy consumption to be presented via the user interface. Further, the HMI device may allow the user to select an option to fill the energy source in full capacity of the energy source if a default setting only allows each user to fill to his or her allowance. Such option is useful when the user needs to take a long journey and does not want to refill the energy source frequently.

Additionally, or alternatively, the HMI device may include a button to enable inputting a number of users for the vehicle so as to set up an allowance for each user. An authorization may be set up in a way so that only a designated person such as a manager of the shared vehicle can activate the function. In some embodiments, the authorized person may allocate the allowance evenly among the plurality users of the shared vehicle. In some embodiments, the authorized person may allocate the allowance differently among the plurality of users. For example, the authorized person may assign allowance to first and second users and exempt a third user the responsibility to refill the vehicle for a vehicle shared by three users in the situation where the third user does not user the vehicle frequently.

The energy source filling management system 12 of the present disclosure assigns an allowance or a fraction of the energy source among a plurality of users of the vehicle, identifies a user for each trip, determines and displays the energy consumption relative to the allowance for the identified user. In this way, each user is acknowledged the energy consumption relative to his or her allowance, the time to refill the energy source or the amount of energy needs to be refilled.

The energy source filling management device 22 may further include a refilling regulator 28 to control the maximum capacity that each user can fill up the energy source 16. In a vehicle powered by a gasoline or diesel or a hybrid vehicle in which the energy source is a fuel tank, the refilling regulator may be a flap moveable by an actuator. In an electric vehicle in which the energy source is a battery, the refilling regulator 28 may be a switch in a charge circuit that connects the circuit to charge the battery and disconnect the circuit to stop the charging the battery. The refilling regulator 28 may be controlled by the energy source filling management device 22. When it is determined that the maximum capacity or allowance for the user is reached during the energy refilling, the energy source filling management device 22 may control the refilling regulator 28 to stop refilling the fuel into the fuel tank by shutting down the fuel passage in the fuel tank via the flap or stop charging the battery by disconnecting the charge circuit.

The refilling regulator 28 enables each user of the shared vehicle to fill up the energy source to the allowance allocated to him or her automatically. The effect is a virtual cap that limits the maximum amount of the energy that each user can refill the energy source. In this way, each user can manage the energy source as if the user has his or her own energy source in the vehicle.

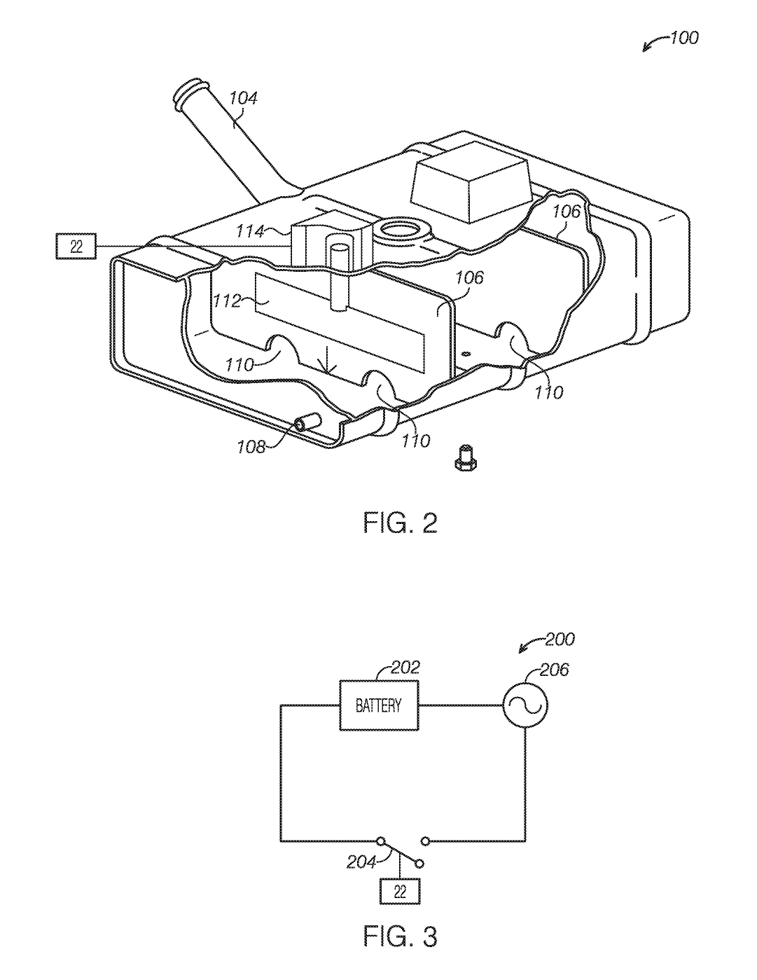

FIG. 2 is an example fuel tank 100 using a flap 102 as a refilling regulator in a shared vehicle by a plurality of users. The fuel tank 100 may be an energy source in a vehicle powered by gasoline or diesel or an energy source in a hybrid vehicle. The fuel tank 100 may include a filler pipe 104 to receive the fuel from a fuel nozzle (not shown), baffles 106 and a fuel outlet 108. Recesses wider the baffles may form fuel passages 110. A flap 112 may be disposed to block the fuel passage 110. In the depicted embodiment, the flap 112 includes a plate that is substantially parallel to a plane of the baffle 106. When an end of the flap is moved to a bottom of the fuel tank 100 by an actuator 114, the fuel passage 110 is blocked and the fuel filling is stopped.

The actuator 114 may be powered by a hydraulic drive or electric motor (not shown) and configured to actuate the flap 112 according to a command from the energy source filling management device 22 as described in FIG. 1. The energy source filling management device 22 may determine an amount of fuel that needs to be filled when a user starts refilling. In some embodiments, the energy source filling management device 22 may determine that the user is about to refill the fuel tank when the opening of a fuel tank cap (not show) is detected by a fuel tank cap monitor sensor (not shown). The fuel tank cap monitoring sensor may be any suitable sensor such as an electromechanical sensor or a reed sensor. The fuel tank cap monitoring sensor may be electrically communicated with the energy source filling management device 22. The energy source filling management device 22 may control the actuator 114 to move down the flap to block the fuel passage 110 when the gasoline or diesel is filled up to the determined amount. In this way, each user can only fill the gasoline up to an allowance allocated to him or her.

In some embodiments, the flap 112 may be moved up after the fuel tank cap monitoring sensor detects that the fuel tank cap is in place to close the fuel tank. In this way, the fuel passage is open and in a status ready to receive the fuel.

FIG. 3 is an example battery charge circuit 200 used in a system to manage filling an energy source in a vehicle shared by a plurality of users. The charge circuit 200 may include a battery 202, a switch 204, and an electric power source 206. The battery 202 may be any battery used to power an electromotor in an electric vehicle and may be charged by connecting to the electric power source 206. The switch 204 may he functioned as a refilling regulator in the system to manage filling an energy source. The switch 204 may he configured to he in a position to close the charge circuit 200 for charging when the battery is plugged to the electric power source 206. When the battery is charged to an allowance for a user, the switch 204 may be switched to a position to open the charge circuit 200 and disconnect the battery 202 with the charge circuit 200 in response to instruction from an energy source filling management device 22.

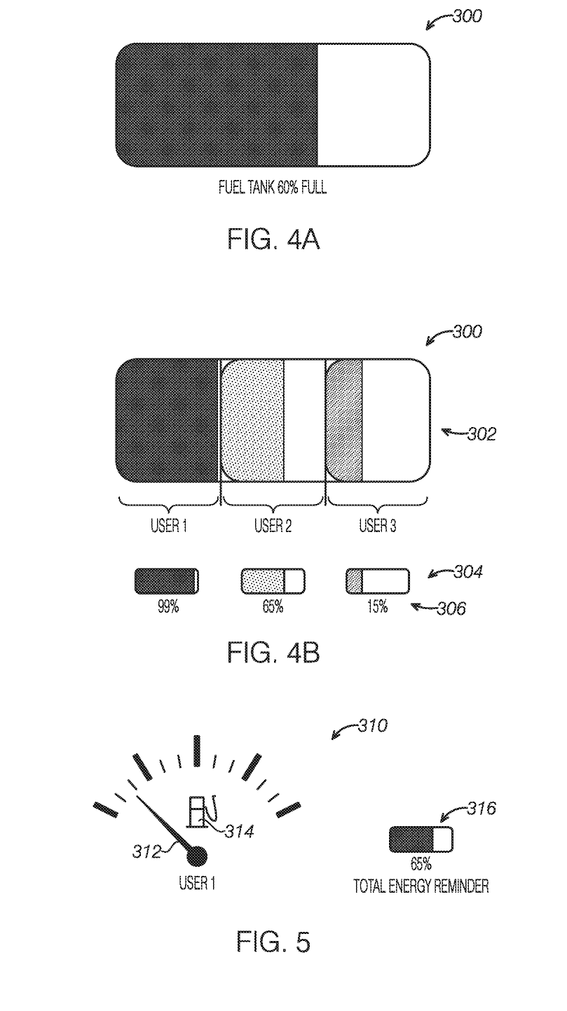

FIGS. 4A and 4B illustrate example energy consumption relative to an allowance for a fuel tank in a shared Vehicle. It should be noted that the energy consumption may include information on the energy remained and energy consumed. In the depicted embodiment, the vehicle is shared by three users and each user is allocated one third of volume or capacity of a fuel tank 300. FIG. 4A shows that the fuel tank 300 is 60% full in its total capacity. FIG. 4B shows that the 60% of fuel is split among the three users relative to their allowances. In the depicted embodiment, a bar graph 302, 304 and a percentage representation 306 are used to show a percentage of fuel consumption relative to the allowance for each user. At a condition illustrated in FIG. 4B, the User 1 has 99% of allowanceremained, the User 2 has 65% of allowance remained and the User 3 has 15% of allowance remained as shown by the bar graph and the percentage representation. In some embodiments, only the energy consumption for an identified user may be displayed when the identified user is driving or using the vehicle. The display illustrated in FIG. 4B may be shown when the user selects an option to view an overall status of the fuel consumption among the users.

The fuel condition in FIG. 4B indicates that the User 3 needs to refill the fuel tank soon. The refilling by the User 3 may only impact the portion of the fuel tank of the User 3. In other words, the fuel consumption status of the User 3 become 100% full after refilling. However, the fuel consumption statuses of the User 2 and the User 3 may remain the same as 99% full and 65% full, respectively while he overall tank capacity may become approximately 88% full.

FIG. 5 shows an example display 310 of fuel consumption in a fuel tank for one of a plurality of user in a shared vehicle. In the depicted embodiment, the energy consummation relative to an allowance for the User 1 is presented in a format similar to that in a conventional fuel gauge display. A handle 312 indicates a current fuel level relative to a full capacity for the User 1 or the allowance to the User 1. The display may further include a sign 314 which is capable of being lightened or flashed to alert the User 1 to refill the fuel tank when the fuel level reaches a predetermined level. The predetermined level is lower than the allowance. Additionally or alternatively, the display 310 may display the energy consumption relative to an entire fuel tank. In the depicted embodiment, a bar graph 316 shows that the actual fuel tank is 65% full relative to an entire capacity of the fuel tank.

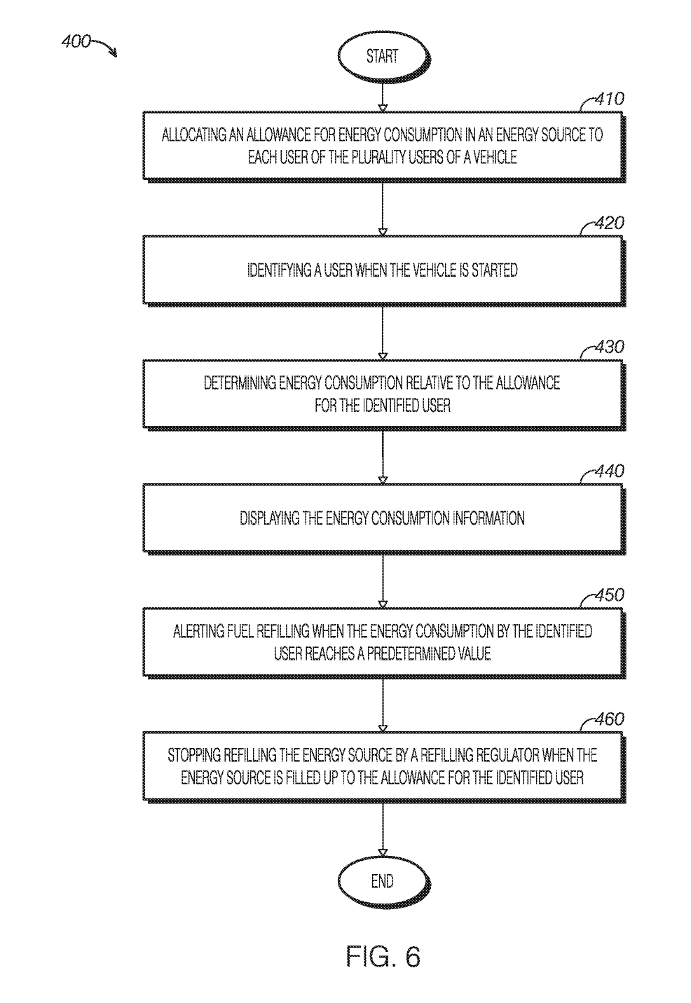

FIG. 6 shows an example method 400 to manage filling an energy source in a shared vehicle by a plurality of users according to an embodiment of the present disclosure. At 410, method 400 may include allocating an allowance for energy consumption in the energy source to each user of the plurality of users of the vehicle. In some embodiments, the allocation may be performed in a registration process for the shared vehicle. In some embodiments, the allocation may be performed when the vehicle is assigned to the plurality of users. The allocation of the allowance may be enabled by inputting the number of the users via an in-vehicle device or any suitable approach. In sonic embodiments, a capacity or a volume of the energy source may be evenly allocated among the plurality of the user. For example, in a vehicle shared by four users, each user may be allocated 25% of the volume of a fuel tank of the vehicle. It should be appreciated that the vehicle may be shared by two users, three users, four users or more than four users.

Step 410 may be a registration process or a process in which the vehicle is assigned to a plurality of users and step 410 may not be performed during the following steps of the method 400. During the usage of the vehicle, the method 400 may start from step 420.

At 420, method 400 may include identifying a user when a vehicle is started. The user may be identified by a user identification device that is capable of identifying the user when the vehicle is started or when the vehicle starts consuming the energy. In some embodiments, the user identification device may be a coded vehicle key. Each user has a vehicle key with a code different from the others. The user identification device may include device to identify finger print or any suitable device.

Upon the recognition of the user, method 400 may include determining the energy consumption relative to the allowance for the identified user at 430. The energy consumption relative to the allowance may be calculated as a percentage of energy used relative to the allowance or a percentage of energy remained relative to the allowance or in any suitable format. The energy consumption for the identified user may be determined based on the energy consumption from previous trips and a current energy consumption. For example, the method may record an energy level for the identified user after each trip and calculate the energy consumption of current use. The current energy consumption for the identified user may be calculated as a difference of the energy level of previous trip and a current energy level measured by an energy gauge.

Next, method 400 may include displaying energy consumption information of the user on an in-vehicle device at 440. The energy consumption information may include any suitable format to represent the energy consumption relative to the allowance for the identified user. For example, the energy consumption information for an individual user may be displayed in a format in a conventional fuel gauge. The display may include a semi-circle scale starting from empty to full capacity allocated to the individual user and the energy level may be indicated by a handle. In another example, the energy consumption information may be displayed in a numeric format and/or a graphic format. In this way, the user is informed of usage of his or her allowance and aware of the time to refill the energy source. As described above, the energy consumption information may be display on a device on a cluster of an instrument panel or may be displayed in an HMI device.

At 450, method 400 may further include alerting fuel refilling when the energy consumption by the identified user reaches a predetermined value. The predetermined value may be lower than the allowance. In some embodiments, the display of the energy consumption information may include a conventional sign for fuel refilling. The alerting fuel refilling may include lightening or flashing the sign for fuel refilling. In some embodiments, alerting fuel refilling may include issuing an audio notice, or displaying a written notification via a device on a cluster of an instrumental panel. In some embodiments, the amount of energy needs to be filled to reach the allowance may be displayed so that the user is informed of the amount needs to be refilled. Alternatively or additionally, a percentage or an amount of the energy in the entire energy source may be displayed to update the user a total energy storage in the entire tank.

The method described above enable the user of a shared vehicle know the energy consumption of his or her allowance and thus manage refilling the energy source accordingly.

Further, at 460, method 400 may comprise stopping to refill the energy source by a refilling regulator when the energy source is filled up to the allowance for the identified user. In some embodiments, the energy source is a fuel tank and the refilling regulator may be a flap disposed in a fuel passage in the fuel tank. The flap may be actuated to shut down the fuel passage by an actuator in response to a command from the energy source filling management device. In some embodiments, the energy source is a battery and the refiling regulator may be a switch in a charge circuit. The switch may disconnect the charge circuit in response to a signal sent by an energy source filling management device when the electricity is charged to the allowance for the user. As the energy refilling can be stopped automatically when the energy is filled up to the allowance for the user, the user does not need to control the amount to be filled manually. In this way, the user can manage refilling as if the user has his or her own single energy source with a maximum capacity (i.e., allowance).

The method 400 may be implemented in a program code or an application. In sonic embodiments, the application to manage energy source refilling in a shared vehicle may be available as an option or a standard of a vehicle. In sonic embodiments, the application to manage energy source refilling in a shared vehicle may be available for purchasing by a user,

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

What is claimed is:

1. A system to manage filling an energy source in a shared vehicle by a plurality of users, each user is allocated an allowance of energy stored in the energy source, the system comprising:
a user identification device to identify a user when the vehicle is started;
an energy source filling management device configured to determine energy consumption relative to the allowance for an identified user; and
an in-vehicle device to display information on the energy consumption relative to the allowance.

2. The system of claim 2, wherein the information on the energy consumption includes at least one of a percentage of allowance remained for the identified user, a scale indicating the energy consumption with the allowance as a full capacity, and an amount of energy needed to be refilled.

3. The system of claim 1, wherein the energy source filling management device is further configured to instruct the user to refill the energy source via the in-vehicle device when the energy used by the identified user reaches a predetermined value, and wherein the predetermined value is lower than the allowance allocated to the identified user.

4. The system of claim 1, further comprising a refilling regulator coupled in the energy source and configured to stop energy refilling when the energy is filled to the allowance of the identified user.

5. The system of claim 4, wherein the energy source filling management device is configured to allow filling to a full capacity of the energy source upon a user's request via the in-vehicle device.

6. The system of claim 1, wherein the energy source filling management device is configured to record an energy level for the identified user after each trip and determine the current energy consumption relative to the allowance according to a difference between an energy level of a previous trip and a current energy level measured by an energy gauge, and the allowance.

7. The system of claim 1, wherein the plurality of users includes two users, three users or four users.

8. The system of claim 1, wherein the allowance is evenly allocated among the plurality of users.

9. The system of claim 4, wherein the vehicle is a gasoline powered vehicle, the energy source is a fuel tank, and the refilling regulator is a moveable flap that enables opening and blocking a fuel passage.

10. The system of claim 13, wherein the vehicle is an electric vehicle, the energy source is a battery, and the refilling regulator is a switch that enables connecting and disconnection a circuit to charge the battery.

11. A system to manage filling an energy source in a shared vehicle by a plurality of users, comprising:
a user identification device to identify a user of the shared vehicle when the vehicle is started;
an energy source filling management device configured to determine energy consumption relative to an allowance allocated to the identified user and time to issue an alert to refill the energy source; and
an in-vehicle device to display the energy consumption relative to the allowance by the identified user.

12. The system of claim 11, wherein the energy source filling management device is further configured to issue the alert when the energy used by the identified user reaches a predetermined value, wherein the predetermined value is lower than the allowance allocated to the user, and wherein the alert is displayed in the in-vehicle device.

13. The system of claim 12, further comprising a refilling regulator to stop refiling the energy source when the energy is filled to the allowance.

14. A method to manage filling an energy source in a shared vehicle by a plurality of users, each user is allocated to an allowance, the method comprising:
identifying a user when a vehicle is started;
determining an amount of the energy consumption relative to the allowance for the identified user; and
displaying energy consumption information of the identified user on an in-vehicle device.

15. The method of claim 14, further comprising alerting fuel refilling when the energy consumption by the identified user reaches a predetermined value, wherein the predetermined value is lower than the allowance.

16. The method of claim 15, wherein alerting fuel refilling includes showing a sign that the energy source needs to be refilled on a cluster of an instrumental panel, issuing an audio notice, or displaying a written notification on a cluster of an instrumental panel or a screen of an HMI device.

17. The method of claim 14, further comprising stopping to refill the energy source by a refilling regulator when the energy source is filled up to the allowance for the identified user.

18. The method of claim 17, wherein the energy source is a fuel tank, and the refilling regulator is a moveable flap that opens and blocks a fuel passage in the fuel tank.

19. The method of claim 14, wherein the energy source is a battery, and the refilling regulator is a switch that connects and disconnect a charge circuit.

20. The method of claim 1, wherein the user is identified by a fingerprint, a voice, a facial feature, an electronic chip embedded in a vehicle key, or via a near field communication technology.
